(19) United States
(12) Patent Application Publication
(10) Pub. No.: US 2021/0232157 A1
(43) Pub. Date: Jul. 29, 2021

(54) METHOD FOR SETTING A VEHICLE DECELERATION OF A VEHICLE IN A PLATOON, PLATOONING CONTROL SYSTEM AND VEHICLE

(71) Applicant: WABCO GmbH, Hannover (DE)

(72) Inventors: Thomas Dieckmann, Pattensen (DE); Ralph-Carsten Luelfing, Garbsen (DE); Stephan Kallenbach, Hannover (DE)

(21) Appl. No.: 17/264,857

(22) PCT Filed: Jul. 3, 2019
(86) PCT No.: PCT/EP2019/067836

§ 371 Date: Feb. 1, 2021

(30) Foreign Application Priority Data
Aug. 2, 2018 (DE) 10 2018 118 744.0

(51) Int. Cl. G05D 1/02; B60W 30/165; G08G 1/00; B60W 30/09

(52) U.S. Cl. CPC G05D 1/0293; B60W 30/165; B60W 2556/45; B60W 30/09; G05D 2201/0213; G08G 1/22

(57) ABSTRACT

A method for setting a vehicle deceleration of a first vehicle travelling in a platoon includes setting, in the presence of a platooning mode, (i) a predetermined target distance between the first vehicle as a guide vehicle and a second vehicle following immediately behind the first vehicle and/or (ii) a predetermined target distance between the first vehicle as a following vehicle and a third vehicle travelling immediately in front of the first vehicle and at least one further vehicle following immediately behind the first vehicle. The method further includes limiting the vehicle deceleration of the first vehicle as the guide vehicle or as the following vehicle to a limit deceleration when a limitation criterion is met.

### CROSS REFERENCE TO RELATED APPLICATIONS

This application is a U.S. National Phase Application under 35 U.S.C. § 371 of International Application No. PCT/EP2019/067836, filed on Jul. 3, 2019, and claims benefit to German Patent Application No. DE 10 2018 118 744.0, filed on Aug. 2, 2018. The International Application was published in German on Feb. 6, 2020, as WO 2020/025243 A1 under PCT Article 21(2).

### FIELD

The present disclosure relates to a method for setting a vehicle deceleration of a vehicle, in particular a utility vehicle, in a platoon as well as a platooning control system for carrying out the method and a vehicle with such a platooning control system.

### BACKGROUND

It is known that multiple vehicles can move in a coordinated manner on a road at short intervals in order to save fuel by reducing air resistance. For this purpose, the distances between the individual vehicles of the platoon can be less than the current safety distances if the vehicles coordinate with each other, for example, via wireless communication. The individual vehicles of the platoon are coordinated by means of a platooning control system, which is installed in each of the vehicles, wherein the platooning control systems in the respective vehicles can communicate with each other via wireless communication and can exchange geometric and/or dynamic driving information, for example.

This allows, for example, a vehicle speed of the individual vehicles as well as a target distance between the individual vehicles of the platoon to be specified according to certain criteria. This ensures that the individual vehicles of the platoon can react more quickly to each other, whereby undercutting the safety distance without a significant impairment of safety is ensured, since the reaction times are reduced.

Problems may arise, however, from the fact that the maximum braking capacity or a maximum deceleration or even a minimum braking distance of the individual vehicles is not exactly known and therefore coordination is difficult. In a manually or automatically initiated braking situation, for example in an emergency braking situation, this can lead to the fact that at very small distances between the vehicles in the platoon and high vehicle decelerations, rear-end collisions can occur if each of the vehicles brakes with its individual maximum deceleration and the target distances are not adapted to this. This is the case, for example, if a leading guide vehicle has a higher maximum deceleration or a higher maximum braking capacity than a following vehicle behind it.

It is difficult to coordinate between the individual vehicles of the platoon since the maximum deceleration of individual vehicles in the platoon is not always known or is only very inaccurately known. This follows from the fact that the maximum deceleration has not been determined in advance or the maximum braking capacity for each vehicle may also change depending on the load or trailer configuration or depending on environmental conditions. For braking situations with high vehicle decelerations, especially in emergency braking situations, safe driving in a platooning mode cannot always be guaranteed.

In U.S. Pat. No. 9,632,507 B1 it is described that the vehicles of the platoon are ordered according to their braking capacity, which is characterized by a maximum deceleration assigned to the respective vehicle. This ensures that a vehicle in front cannot brake more strongly than a following vehicle.

Problems may arise from the fact that the maximum braking capacity or the maximum deceleration of the individual vehicles is not exactly known. This may, in particular in an emergency braking situation, lead to rear-end collisions in the event of a very small interval between the vehicles in the platoon, if each of the vehicles brakes with its individual maximum deceleration. This is the case, for example, if a vehicle ahead has a higher maximum deceleration than the vehicle behind it. It is difficult to coordinate between the individual vehicles of the platoon because the maximum decelerations are not known or are only very inaccurately known. For emergency braking situations, therefore, safe driving in a platooning mode cannot always be guaranteed.

In accordance with WO 2016/135207 A1 and WO 2016/134770 A1, it is also provided that the distance between the vehicles of the platoon will be adjusted when a possible collision is detected. Depending on the braking capacity or the maximum deceleration of the respective vehicle, a buffer distance between the respective vehicles is taken into account. The braking capacity for each vehicle is estimated from a frictional analysis and is therefore determined while driving.

The prior art therefore assumes that the maximum deceleration of a vehicle is exactly known. In fact, this is not the case. Rather, a variety of parameters have an influence on the maximum deceleration. For example, this can already change continuously due to wear. A current value of the maximum deceleration can therefore only be determined by, for example, repeated daily braking tests, which is not practical.

### SUMMARY

In an embodiment, the present invention provides a method for setting a vehicle deceleration of a first vehicle travelling in a platoon. The method includes setting, in the presence of a platooning mode, (i) a predetermined target distance between the first vehicle as a guide vehicle and a second vehicle following immediately behind the first vehicle and/or (ii) a predetermined target distance between the first vehicle as a following vehicle and a third vehicle travelling immediately in front of the first vehicle and at least one further vehicle following immediately behind the first vehicle. The method further includes limiting the vehicle deceleration of the first vehicle as the guide vehicle or as the following vehicle to a limit deceleration when a limitation criterion is met.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view of a platoon of several vehicles; and

FIG. 2 shows a flowchart for carrying out a method according to an embodiment.

### DETAILED DESCRIPTION

The present disclosure provides a method for setting a vehicle deceleration of a vehicle in a platoon, with which safe driving operation of the vehicles of the platoon can be ensured. The present disclosure further provides a platooning control system for carrying out the method and a vehicle with such a platooning control system.

According to the present disclosure, it is therefore provided that the vehicle deceleration of a vehicle which may be on the road as a guide vehicle or a following vehicle in a platoon, is limited to a limit deceleration when a limitation criterion is met, wherein from the limit deceleration it is preferably assumed that each of the following vehicles of the platoon travelling behind the vehicle can implement at least this limit deceleration, so that the vehicle as a leading guide vehicle or as a leading following vehicle can be decelerated as much as any following vehicle of the platoon travelling behind the vehicle in a braking situation.

As a result, the advantage can already be achieved that the vehicles can coordinate in any braking situation, even if the maximum deceleration of at least one vehicle is not known. This means that even in a platoon in which individual vehicles provide no information or only very inaccurate information about the maximum deceleration, a safe driving operation can nevertheless be guaranteed. The limitation thus ensures that the vehicle deceleration of the vehicle is not set higher and thus the vehicle cannot be decelerated more strongly than specified by the limit deceleration, wherein it is assumed from the limit deceleration that this can at least be implemented by any other vehicle in the platoon.

Thus, in principle a higher vehicle deceleration than the limit deceleration can be set for the vehicle, i.e. up to the unknown maximum deceleration, however the setting of higher values than the limit deceleration can be prevented by the limitation.

A platoon can be understood, in the context of the present disclosure, to refer to a vehicle grouping (convoy) of several vehicles, in particular utility vehicles, which move at a small distance from each other. The leading vehicle is referred to as the guide vehicle and the vehicles behind are referred to as following vehicles, wherein there may be only one or multiple following vehicles. Accordingly, a following vehicle can drive behind a guide vehicle and/or can drive in front of a further following vehicle.

The individual vehicles coordinate with each other by wireless communication, so that a correspondingly short set target distance can be set by a platooning control system in each vehicle by controlling a brake and/or drive system. Coordination may be carried out by a coordinating vehicle which may be either the guide vehicle or one of the following vehicles. The distances between the vehicles are coordinated within the platoon so that the fuel consumption can be optimized due to low air resistances throughout the platoon.

Preferably, it is provided that the limit deceleration is determined in compliance with a legally prescribed minimum deceleration. This makes the limit deceleration advantageously dependent on a variable from which it is assumed that this can be met by any vehicle under standard conditions.

In this case, it can preferably be provided that the limit deceleration corresponds exactly to the legal minimum deceleration or a value that deviates from the legal minimum deceleration by a safety factor, wherein the safety factor is between approx. 5% and approximately 20% of the legal minimum deceleration. As a result, the tolerance with which the limitation of the vehicle deceleration is carried out can be advantageously determined. Therefore, if it is assumed that a large number of vehicles can also exceed the legal minimum deceleration, the safety factor can be set high. However, if it is assumed that the vehicles in the vehicle are rather close to the minimum legal requirement, the exact legally specified minimum deceleration value of, for example, 5 m/s² for a truck and 4.5 m/s² for a truck with a trailer will be adopted as the limit deceleration.

Thus, even small deviations are conceivable if it is assumed that only a few vehicles achieve only the legal minimum deceleration at all. As a result, the following distance can be advantageously minimized and safe driving in the platoon can still be guaranteed.

According to a preferred embodiment, it is provided that the limitation criterion is met as soon as the platooning mode in the vehicle is activated. The vehicle deceleration of the vehicle moving in the platoon is thus limited immediately upon entry into the platoon and it is thus ensured that no rear-end collisions occur in a braking situation.

According to an alternative design, it is provided that the limitation criterion is only met if, in the case of monitoring of actual distances between the guide vehicle and a following vehicle directly behind it and/or between two immediately following vehicles of the platoon travelling immediately in succession, it is established during a braking process that the respective actual distance is reduced by at least a limit distance.

Thus, a limitation is only adopted when it is actually determined that there is a difference in the maximum braking capacity of the vehicles. As a result, a possible unnecessary limitation of the vehicle deceleration can be avoided. The limitation only takes place when it is actually established that one of the vehicles in the platoon brakes less strongly than a vehicle in front of it.

For this purpose, it can preferably be provided that the actual distances are determined dynamically by means of distance sensors in the respective following vehicle. Thus, the existing distance sensor of the distance control system, which preferably also provides for the setting of the target distance, can also be used to detect the difference or deviation in the braking capacity and thus to evaluate whether a limitation is necessary.

Preferably, it is also provided that meeting the limitation criterion is transmitted via a wireless data communication to the vehicle as a guide vehicle or as a following vehicle, so that the vehicle deceleration of the vehicle can then be limited to the limit deceleration. Advantageously, it can therefore be recognized by any vehicle in the platoon that a different braking capacity is present and thus a limitation is necessary, and this realization is forwarded to the other vehicles in the platoon, which then implement the limit. This can also be coordinated via the coordinating vehicle.

In accordance with a further design, provision may be made for the limitation criterion for the vehicle to be permanently defined as not being met if the vehicle is a following vehicle which is not followed by another following vehicle in the platoon. Accordingly, it can be advantageously stipulated for the last vehicle in the platoon that it can also brake more strongly independently of the other vehicles, since the last vehicle cannot be involved in a rear-end collision with following vehicles in the platoon.

Preferably, it is provided that the limit deceleration is determined by a coordinating vehicle of the platoon and transmitted to the vehicle or the limit deceleration is determined by the vehicle itself. Thus, independently of the other vehicles, the particular vehicle can immediately implement the limitation or, in the event of deviation from a certain parameterization, can also adopt the data from the coordinating vehicle.

According to a preferred development, it is provided that the target distances from the coordinating vehicle are determined and transmitted at least to the following vehicles, wherein the following vehicles control the respective target distance by means of a distance control system. Thus, a centrally coordinated platoon is advantageously assumed.

Preferably, it is also provided that the braking situation of the vehicle, for which the vehicle deceleration is limited to the limit deceleration, is initiated automatically or manually. The braking situation can be an emergency braking situation, for example. Thus, both manual intervention by the driver or automated intervention by a driving assistance system are captured by the limitation, wherein high vehicle decelerations, for which the limitation is preferred, occur in particular in manually or automatically initiated emergency braking. But also other braking processes with high vehicle decelerations in the region of the limit deceleration benefit from the limitation, since rear-end collisions can also be avoided in these cases.

According to a preferred implementation, it is further provided that the limitation of the vehicle deceleration to the limit deceleration when the limitation criterion is met is monitored by a platooning control system or by the brake system of the vehicle. Thus, the platooning controller itself can ensure compliance with the limit and may overwrite a braking requirement in a limiting manner, or a limitation command is issued to the brake system, which thus itself ensures that no braking is carried out with a vehicle deceleration greater than the limit deceleration.

According to the present disclosure, the platooning control system can be designed to arrange, in active platooning mode, that a fixed target distance is set between the vehicle as a following vehicle and the immediately preceding guide vehicle or another preceding following vehicle of the platoon, wherein the platooning control system may cause automated control of a brake system and/or a drive system of the vehicle and the platooning control system is further designed, on meeting a limitation criterion, to cause limitation of the vehicle deceleration of the vehicle to a limit deceleration as described.

In this case, the platooning control system may comprise a distance control system or may be connected to a distance control system with distance sensors, in order to set the target distance in a vehicle as a following vehicle and possibly to monitor the actual distances.

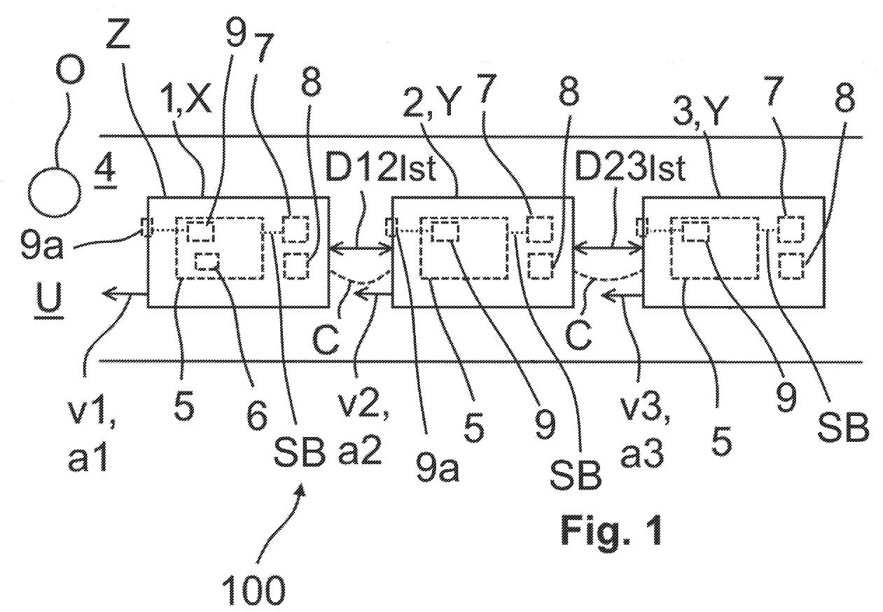

According to FIG. 1, a platoon 100 or a convoy of three vehicles 1, 2, 3 is shown, wherein the vehicles 1, 2, 3 are moving on a road 4 one after the other. The leading vehicle 1 is hereinafter referred to as the guide vehicle X and the vehicles 2 and 3 behind as following vehicles Y of the platoon 100. More than two following vehicles Y may also be envisaged. An actual distance D12Ist, D23Ist between the individual vehicles 1, 2, 3 is controlled to a predetermined target distance D12Soll, D23Soll in a platooning mode P so that the air resistance and the use of space between the individual vehicles 1, 2, 3 of the platoon 100 is optimized.

To achieve this, the actual distances D12Ist, D23Ist are each automatically adjusted by a platooning control system 5 which is installed in each of the vehicles 1, 2, 3. The setting of the actual distance D12Ist, D23Ist is carried out by a distance control system 9 in the respective following vehicle Y, which according to the type of an adaptive cruise control (ACC) determines the current actual distance D12Ist, D23Ist between the particular following vehicle Y and the respective leading vehicle 1, 2 (guide vehicle X or further following vehicle Y) by means of distance sensors 9a and adjusts this to the set target distance D12Soll, D23Soll specified for the particular following vehicle Y.

The platooning control system 5 has a suitable working connection to the distance control system 9 or is combined with this in a unit. Since the guide vehicle X can in principle also be a following vehicle Y in a differently assembled platoon 100, this may also have the described distance control functions.

The platooning control systems 5 of the individual vehicles 1, 2, 3 can coordinate with each other, so that the driving dynamics, in particular a vehicle speed v1, v2, v3 and/or a vehicle deceleration a1, a2, a3, of the respective following vehicle Y and/or in certain situations also of the guide vehicle X, can be adjusted in terms of safety aspects such that the predetermined target distance D12Soll, D23Soll will be adhered to. The platooning control systems 5 have a working connection for this purpose, for example, to brake and drive systems 7, 8 in the respective following vehicle Y or guide vehicle X, so that the driving dynamics can be changed automatically, wherein braking is possible both by means of wheel brakes or retarders controlled by the brake system 7 as well as by means of engine braking controlled by the drive systems 8.

The target distance D12Soll, D23Soll between the individual vehicles 1, 2, 3 can be determined centrally by only one of the vehicles 1, 2, 3 of the platoon 100, for example, the guide vehicle X, on the basis of driving dynamic criteria in its platooning control system 5 and can be specified to the individual following vehicles Y. The guide vehicle X therefore acts simultaneously as a coordinating vehicle Z, which coordinates the platoon 100 depending on the exchanged data. The coordinating vehicle Z can in principle also be one of the following vehicles Y. The determination and specification of the target distance D12Soll, D23Soll can in principle also be carried out decentrally in each of the vehicles 1, 2, 3 on the basis of exchanged data.

The coordination or the data exchange between the individual vehicles 1, 2, 3 is carried out via a wireless data communication C, through which, for example, geometric and/or dynamic driving information about the individual vehicles 1, 2, 3 and/or concerning an environment U can be transmitted. Also the predetermined target distance D12Soll, D23Soll can be transmitted from the coordinating vehicle Z to the other vehicles 1, 2, 3. By such matching or coordination of the individual vehicles 1, 2, 3 of the platoon 100, target distances D12Soll, D23Soll between the individual vehicles 1, 2, 3 which lie below a safety distance can be specified and adjusted. As a result, the air resistance and thus also the fuel consumption can be reduced.

With such coordination, certain assumptions are conventionally made about the maximum braking capacity of the vehicles involved 1, 2, 3, which are not reliable in every driving situation. The maximum braking capacity of a vehicle 1, 2, 3 is sometimes not known or only known very inaccurately, since it was not determined, for example, in test braking or may also vary depending on the configuration of the brake system 7, the loading, a trailer configuration or environmental conditions. A maximum deceleration aMax1, aMax2, aMax3 characterizing the maximum braking capacity of the respective vehicle 1, 2, 3 indicates the maximum deceleration with which the respective vehicle 1, 2, 3 can be braked in a driving situation, therefore the platooning control system 5 is normally not available, in particular to the coordinating vehicle Z, for the coordination of the platoon 100. As a result, the individual platooning control systems 5 cannot reliably coordinate with each other via the wireless communication C in certain driving situations.

As a result, in braking situations with high controlled vehicle decelerations a1, a2, a3, for example in an emergency braking situation N, it can occur that the vehicles 1, 2, 3 are braked with their respective maximum decelerations aMax1, aMax2, aMax3, for which the given target distance D12Soll, D23Soll is however not designed. This may lead to rear-end collisions in the event of different real vehicle decelerations a1, a2, a3, if in such braking situations, for example, the guide vehicle X is decelerated more than the following vehicle Y or vehicles. Such a situation can occur not only in an emergency braking situation N, but in the event of any braking specified manually by the driver or automatically by a driver assistance system (ABS, RSC, etc.), in which in principle a high vehicle deceleration a1, a2, a3 can also be requested.

In order to take account of this circumstance, it is provided that the vehicle deceleration a1, a2, a3 for each vehicle 1, 2, 3 is limited to a limit deceleration aG if a limitation criterion K is present, wherein the limitation criterion K is met in the simplest case, if the respective vehicle 1, 2, 3 is in a platooning mode P. The limit deceleration aG is set to a value that is assumed to be at least implemented by each of the vehicles 1, 2, 3 in the platoon 100. A limit deceleration aG, which can at least be implemented by any of the vehicles 1, 2, 3 of the platoon 100, is most likely a legally prescribed minimum deceleration aM. This should certainly be able to be complied with by each functioning compliant vehicle 1, 2, 3 of the platoon 100 under standard conditions, i.e. at least on dry roads. The legal minimum deceleration aM can be 5 m/s² for trucks, for example, or 4.5 m/s² for trucks with trailers, for example.

As a result it can be achieved, for example, that the following vehicles Y of the platoon 100 in FIG. 1 can always be braked at least as strongly as the guide vehicle X of the platoon 100 in a coordinated braking situation with high requested vehicle decelerations a2, a3, for example in an emergency braking situation N. The same applies to the two following vehicles Y relative to each other. A rear-end collision can therefore at least be avoided safely if the coordinated braking takes place under standard conditions on a dry road 4 and it is assumed that the following vehicles Y do not have a defect in the brakes.

As soon as the platooning mode P is active in one of the vehicles 1, 2, 3, it is thus automatically arranged according to this implementation that a limitation of the vehicle deceleration a1, a2, a3 for the vehicle in question 1, 2, 3 takes place to the limit deceleration aG, preferably the legal minimum deceleration aM. This specification can be carried out individually by the platooning control system 5 in each vehicle 1, 2, 3 as soon as the platooning-mode P is active. The specification can also be carried out centrally starting from the coordinating vehicle Z, for example the guide vehicle X, which in addition to the target distance D12Soll, D23Soll can thus also specify the limit deceleration aG via the wireless communication C, as soon as a new following vehicle Y joins the platoon 100.

The implementation of the limitation to the limit deceleration aG may be carried out, for example, by the platooning control system 5 of each vehicle 1, 2, 3 itself in interaction with brake and drive systems 7, 8 and/or the distance control system 9 and causes the vehicle deceleration a1, a2, a3 to be unable to be set greater than the limit deceleration aG. In platooning mode P the platooning control system 5 is thus able to overwrite any automatically or manually predetermined braking commands in the respective vehicle 1, 2, 3 or to limit these to the limit deceleration aG.

Furthermore, however, a corresponding limiting command SB can also be output to the drive or brake system 7, 8, which then automatically ensures that the limit deceleration aG is not exceeded with platooning mode P activated. Any manual or automated specifications for the brake or drive system 7, 8, for example including manual braking specifications by the driver, are then limited to this limit deceleration aG.

The determination of an emergency braking situation N as an exemplary braking situation with high requested vehicle deceleration a1, a2, a3 by an emergency braking assistant 6, for example in the guide vehicle X, is already carried out based on the limit deceleration aG. I.e. this limit deceleration aG is already used for the calculation of a collision time tCol to a possibly detected collision object O, so that the application of an emergency braking situation N is already based on the actually achievable conditions. Outside of the platooning mode P, the emergency braking assistant 6 can be parameterized back to other values.

Assuming that one of the following vehicles Y may also brake more strongly than the legally prescribed minimum limit deceleration aM with a high probability, the limit deceleration aG may also be set at a value which is higher than the legally required minimum deceleration aM by a safety factor S of between 5% and 15%, for example.

For the last following vehicle Y, 3 in the platoon 100, the limitation of the vehicle deceleration a3 to the limit deceleration aG can be removed since this cannot be involved in a rear-end collision with another following vehicle of the platoon 100 within the platoon 100.

By this measure it can therefore advantageously be achieved that a difference between the set vehicle deceleration a1 for example of the guide vehicle X and the unknown braking capacity (aMax2, aMax3) of the following vehicles Y during a braking situation with high demanded vehicle deceleration a1, a2, a3, for example during an emergency braking situation N, is minimized, since it is assumed that the following vehicle or vehicles Y may be at least decelerated with the limit deceleration aG or the legally prescribed minimum deceleration aM or slightly over this. Thus, a safe driving mode can be ensured at least under standard conditions without rear-end collisions even in platooning mode P.

According to an extended design, it may be provided that the limitation criterion K is only met and that a limitation of the vehicle deceleration a1, a2, a3 to the limit deceleration aG is only carried out when it is actually established that there is a need for a limitation. For this purpose, the actual distances D12Ist, D23Ist between the vehicles 1, 2, 3 in the platooning mode P are dynamically detected and from these an actual distance change dD12Ist, dD23Ist between the respective vehicles 1, 2, 3 is determined. This can be carried out via the distance sensors 9a of the cruise control system 9. If the actual distance change dD12Ist, dD23Ist between the respective vehicles 1, 2, 3 in the event of braking is negative and falls below a certain distance limit value DG, i.e. the respective actual distance D12Ist, D23Ist is reduced in the respective braking situation at least by the distance limit value DG, the limitation criterion K is met, since the respective following vehicle Y moves towards the vehicle 1, 2 ahead in the event of braking due to a lower maximum braking capacity. The distance limit DG is set to take into account an initial reduction of the actual distance D12Ist, D23Ist in the event of braking due to a reaction time of the respective vehicle 1, 2, 3.

Meeting the limitation criterion K may be reported by the respective following vehicle Y to the vehicle ahead 1, 2 and/or the coordinating vehicle Z via the wireless communication C, whereupon the limitation to the limit deceleration aG is applied as described above for the vehicles 1, 2, 3 of the platoon 100. With such an approach, the limitation of the vehicle deceleration a1, a2, a3 in platooning mode P may be limited to the necessary minimum degree, since in fact a limitation takes place only if this is necessary due to an actually detected deviating maximum braking capacity.

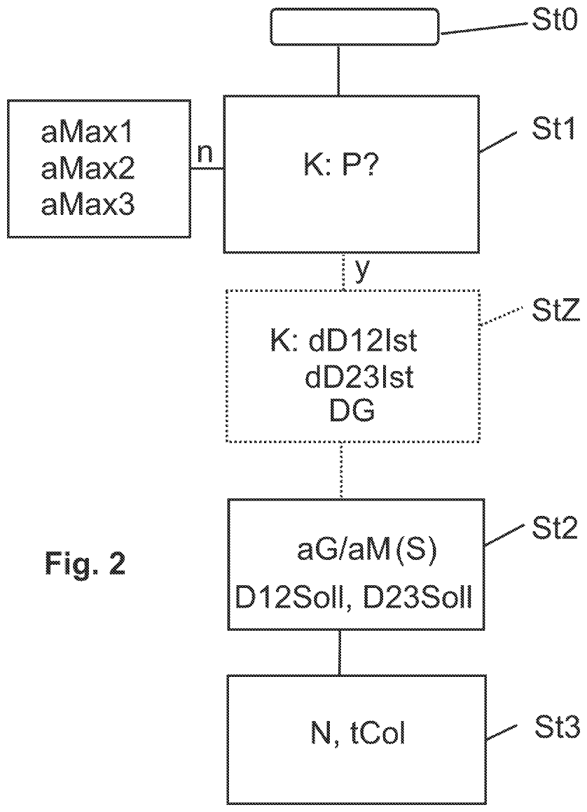

According to FIG. 2, the method can be carried out, for example, as follows. After an initialization in step St0, for example when starting the respective vehicle 1, 2, 3, in a first step St′ a check is first carried out of whether the respective vehicle 1, 2, 3 is in a platoon 100. If this is not the case, no modification takes place in the setting of the vehicle deceleration a1, a2, a3 of the respective vehicle 1, 2, 3. Thus, the vehicle 1, 2, 3 can also be decelerated with the respective maximum deceleration aMax1, aMax2, aMax3.

However, if a platooning mode P exists, in a second step St2 a certain limit deceleration aG is set in the respective vehicle 1, 2, 3 of the platoon 100, which must not be exceeded due to a braking requirement. The limit deceleration aG is set independently in the respective vehicles 1, 2, 3 or specified by the coordinating vehicle Z of the platoon 100 on entry into the platoon 100. The limit deceleration aG is set to a value from which it is assumed that this can at least be implemented by each of the vehicles 1, 2, 3 in the platoon 100. This value can preferably be replaced by the legal minimum deceleration aM, possibly taking into account a safety factor S of for example between 5% and 15%. At the same time, the target distance DS12Soll, DS23Soll is controlled by the distance control system 9 under this condition.

In an optional intermediate step StZ, before braking in platooning mode P it can be checked first whether one of the following vehicles Y is approaching the respective vehicle ahead 1(X), 2(Y) by more than a limit distance. If this check concludes that the maximum braking capacity of one of the following vehicles Y is less than that of the vehicle ahead of it 1 (X), 2 (Y) a specification of the limit acceleration aG for all vehicles 1, 2, 3 of the platoons 100 is carried out.

Thus, meeting the limitation criterion K can already be determined either in step St′ or only in the intermediate step StZ.

During subsequent manually or automatically induced braking, for example during emergency braking N, in a third step St3 the vehicle deceleration a1, a2, a3 of the vehicles concerned 1, 2, 3 is then limited accordingly and it is thus ensured that the vehicle deceleration a1, a2, a3 does not rise above the limit deceleration aG for any braking requirement.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE CHARACTERS

| | |
|---|---|
| 1, 2, 3 | vehicles of the platoon 100 |
| 4 | road |
| 5 | platooning control system |
| 6 | emergency braking assistant |
| 7 | brake system |
| 8 | drive system |
| 9 | distance control system |
| 9a | distance sensor |
| 100 | platoon |
| a1, a2, a3 | vehicle deceleration |
| aG | limit deceleration |
| aM | legal minimum deceleration |
| aMax1, aMax2, aMax3 | maximum deceleration |
| C | wireless data communication |
| D12Ist, D23Ist | actual distance |
| D12Soll, D23Soll | target distance |
| DG | limit distance |
| K | limitation criterion |
| N | emergency braking situation |
| O | collision object |
| P | platooning mode |
| S | safety factor |
| SB | limitation command |
| tCol | collision time |
| U | environment |
| v1, v2, v3 | vehicle speed |
| X | guide vehicle |
| Y | following vehicle |
| Z | coordinating vehicle |
| St0, St1, StZ, St2, St3 | steps of the method |

1. A method for setting a vehicle deceleration of a first vehicle travelling in a platoon, the method comprising:
setting, in the presence of a platooning mode, (i) a predetermined target distance between the first vehicle as a guide vehicle and a second vehicle following immediately behind the first vehicle and/or (ii) a predetermined target distance between the first vehicle as a following vehicle and a third vehicle travelling immediately in front of the first vehicle and at least one further vehicle following immediately behind the first vehicle; and
limiting the vehicle deceleration of the first vehicle as the guide vehicle or as the following vehicle to a limit deceleration when a limitation criterion is met.

2. The method as claimed in claim 1, wherein it is assumed from the limit deceleration that each of the following vehicles of the platoon can at least achieve a limit deceleration, so that a vehicle as a guide vehicle ahead or as a following vehicle ahead is decelerated at the most as much as any following vehicle of the platoon behind the vehicle in a braking situation.

3. The method as claimed in claim 1, wherein the limit deceleration is determined depending on a legally prescribed minimum deceleration.

4. The method as claimed in claim 3, wherein the limit deceleration corresponds to the legal minimum deceleration or a value that deviates from the legal minimum deceleration by a safety factor, wherein the safety factor is between 5% and 20% of the legal minimum deceleration.

5. The method as claimed claim 1, wherein the limitation criterion is met as soon as the platooning mode is activated in the vehicle.

6. The method as claimed in claim 1, wherein the limitation criterion is met if it is determined that the respective actual distance is reduced by at least a limit distance during monitoring of actual distances between the guide vehicle and a following vehicle travelling immediately behind it and/or between two following vehicles of the platoon travelling one immediately behind the other during a braking process.

7. The method as claimed in claim 6, wherein the actual distances are determined dynamically by distance sensors in the respective following vehicle.

8. The method as claimed in claim 6, wherein meeting the limitation criterion is transmitted via a wireless data communication to the vehicle as a guide vehicle or as a following vehicle, so that the vehicle deceleration of the vehicle can be limited to the limit deceleration.

9. The method as claimed in claim 1, wherein the limitation criterion for the vehicle is permanently determined as not met if the vehicle is a following vehicle which is not being followed by a further following vehicle in the platoon.

10. The method as claimed in claim 1, wherein the limit deceleration is determined by a coordinating vehicle of the platoon and transmitted to the vehicle or the limit deceleration is determined by the vehicle itself.

11. The method as claimed in claim 1, wherein the target distances are determined by a coordinating vehicle and transmitted at least to the following vehicles, wherein the following vehicles control the respective target distance by means of a distance control system.

12. The method as claimed in claim 1, wherein the braking situation of the vehicle for which the vehicle deceleration is limited to the limit deceleration is initiated automatically or manually.

13. The method as claimed in claim 11, wherein the braking situation is an emergency braking situation.

14. The method as claimed in claim 1, wherein the limitation of the vehicle deceleration to the limit deceleration on meeting the limitation criterion is monitored by a platooning control system or by the brake system of the vehicle.

15. A platooning control system, the platooning control system being configured to, in an activated platooning mode, to cause a fixed target distance to be set between a following vehicle and a guide vehicle travelling immediately ahead or another following vehicle ahead of the platoon, wherein the platooning control system is configured to initiate automated control of a brake system and/or a drive system of the vehicle,
wherein
the platooning control system is further configured, upon the limitation criterion being met, to initiate limitation of the vehicle deceleration of the vehicle to a limit deceleration.

16. The platooning control system as claimed in claim 15, wherein the platooning control system has a distance control system or has a working connection to a distance control system with distance sensors for setting the target distance in a vehicle as a following vehicle.

17. The platooning control system as claimed in claim 15, wherein the platooning control system is configured to issue a limitation command to the brake system to limit the vehicle deceleration, so that the brake system can limit the vehicle deceleration of the vehicle to the limit deceleration in response to the limitation command.

18. A vehicle with a platooning control system as claimed in claim 15, wherein the vehicle may be a guide vehicle or a following vehicle in a platoon.
